(19) United States
(12) Patent Application Publication
(10) Pub. No.: US 2019/0002251 A1
(43) Pub. Date: Jan. 3, 2019

(54) Crane And Method For Controlling Same

(71) Applicant: Liebherr-Components Biberach GmbH, Biberach an der Riß (DE)

(72) Inventor: Jürgen Resch, Degernau (DE)

(21) Appl. No.: 15/737,770

(22) PCT Filed: Jun. 21, 2016
(86) PCT No.: PCT/EP2016/001055

§ 371 Date: Dec. 19, 2017

(30) Foreign Application Priority Data
Jun. 23, 2015 (DE) 10 2015 008 038.5

(51) Int. Cl. B66C 13/22; B66C 19/00

(52) U.S. Cl. CPC B66C 13/22; B66C 2700/01; B66C 2700/08; B66C 19/007

(57) ABSTRACT

A crane including electric actuators for lifting and/or traveling loads and/or crane elements, a generator for supplying the actuators with energy, an internal combustion engine for driving the generator, inputs for entering control commands for the actuators, and a control device for controlling the actuators in dependence on the control commands entered. The control device has a determination device for determining and/or estimating a future power demand of the electric actuators with reference to the actuation of the inputs with which control commands for the actuators are entered, and the current operating condition of the actuators, and an engine control unit for controlling the internal combustion engine in dependence on the estimated/determined future power demand.

### CROSS-REFERENCE TO RELATED APPLICATIONS

This is a § 371 national stage of International Application PCT/EP2016/001055, with an international filing date of 21 Jun. 2016, which claims the benefit of DE Patent Application Serial No. 10 2015 008 038.5, filed on 23 Jun. 2015, the benefit of the earlier filing date of which is hereby claimed under 35 USC § 119(a)-(d) and (f). The entire contents and substance of all applications are hereby incorporated by reference.

### BACKGROUND OF THE INVENTION

### 1. Field of the Invention

The present invention relates generally to a crane, in particular in the form of a container stacking or gantry crane, having electric actuators for lifting and/or traveling loads and/or crane elements, a generator for supplying the actuators with energy, an internal combustion engine for driving the generator, input means for entering control commands for the actuators, and a control device for controlling the actuators in dependence on the control commands entered. The invention furthermore relates to a method for controlling such crane.

### 2. Description of Related Art

In the context of the present application the term “crane” is to be understood broadly and in the broadest sense also can comprise industrial trucks such as rack conveyors, fork lift trucks or other lifting devices such as straddle carriers, wherein in particular container stacking cranes, harbor gantry cranes, so-called RTG cranes, i.e. gantry cranes with rubber tires for containers, but also construction cranes in the form of for example tower cranes, telescopic cranes or derrick cranes can be meant.

In such electric cranes, i.e. cranes with electric drives, which are supplied by a generator that is operated with an internal combustion engine, an above-average fuel consumption usually occurs at idle or in partial-load operation, as the generator unit usually is operated with a fixed frequency of for example 50/60 Hertz.

To lower the consumption at idle, approaches already exist in which the speed of the internal combustion engine is lowered when all electric drives are shut off. When using a frequency converter for actuating the electric drives, it no longer is necessary to provide a voltage supply with fixed frequency for example in the form of the aforementioned 50/60 Hertz supply. As the grid frequency applied to the actuators by the frequency converter can be varied with respect to the generator speed, it is possible to operate the internal combustion engine which drives the generator with a freely selectable frequency. The speed of the internal combustion engine thereby can be chosen such that the internal combustion engine is operated in its consumption optimum, i.e. in an operating range with losses as low as possible and/or a consumption as low as possible.

When the speed of the internal combustion engine is lowered in this way and/or an optimum operating point of the internal combustion engine in terms of consumption is adjusted, a reduced crane performance can occur, however, in that for example only reduced positioning speeds can be realized or limited loads can be lifted. In the worst case, it also can occur that the internal combustion engine is stalled and the crane must be started again, before the lifting or positioning task can be executed.

Therefore, it has already been proposed to no longer feed the electric actuators with electric energy directly by the generator, but to interpose a battery or an accumulator into which the electric energy produced by the generator is stored and from which the electric actuators can then be supplied, cf. US 2012/0089287 A1. Via the buffering effect of the accumulator the load of the internal combustion engine can be rendered more uniform and performance peaks of the electric actuators can be leveled off. However, the interposition of such accumulator and its control as regards the feeding in and feeding out of electric power requires additional electric controller components. In addition, the batteries themselves not only are heavy and expensive, but also limited in their service life.

It therefore is the object underlying the present invention to indicate an improved crane and an improved method for controlling such crane, which avoids the disadvantages of the prior art and develops the latter in an advantageous way. The fuel demand of a crane provided with electric actuators is to be reduced as far as possible without noticeably impairing the crane performance.

### SUMMARY OF THE INVENTION

According to the invention, the object is solved by a crane comprising electric actuators, a generator for supplying the electric actuators with energy, an internal combustion engine for driving the generator, input means for entering control commands for the actuators, and a control device configured to control the actuators in dependence on the control commands entered, wherein the control device comprises a determination device configured to estimate and/or determine a future power demand of the actuators on the basis of the actuation of the input means and the current operating condition of the actuators, and an engine control unit configured to control the internal combustion engine in dependence on the estimated/determined future power demand.

According to the invention, the object is also solved by a method for controlling a crane with electric actuators for lifting and/or traveling loads and/or crane elements, a generator for supplying the electric actuators with energy, an internal combustion engine for driving the generator, input means for entering control commands for the actuators, and a control device for controlling the actuators in dependence on the control commands entered, the method comprising detecting an actuation of the input means and/or the control commands generated by the actuation of the input means, calculating and/or estimating and/or determining a future power demand of the actuators by the control device with reference to the detected actuation of the input means and/or with reference to the detected control commands generated by the actuation of the input means, and adjusting the internal combustion engine with regard to the speed and/or torque to an operating point in which the internal combustion engine provides the calculated/estimated power demand substantially without an excess of power, before the actuators reach the operating point requested by the control commands of the input means and the corresponding power demand.

It hence is provided to lower the speed and/or the torque of the internal combustion engine at idle or in partial-load operation of the electric actuators, but to again raise the rotational speed and/or the torque of the internal combustion engine in time, before the actuators again require a higher power or even the full power. So as not to suffer any limitations in crane operation or even stall the internal combustion engine, the operation of the internal combustion engine is not trailing behind the actual power demand of the actuators, but is leading to satisfy an only future power demand of the electric actuators. According to the invention the control device has a determination device for determining and/or estimating a future power demand of the electric actuators with reference to the actuation of the input means with which control commands for the actuators are entered, and with reference to the current operating condition of the actuators, and an engine control unit for controlling the internal combustion engine in dependence on the estimated/determined future power demand. Since the control device anticipates the power demand of the actuators before the actuators actually reach the operating point at which this power demand occurs, the internal combustion engine can timely be moved to an operating point optimal or at least suitable for this power demand. The speed and/or the torque of the internal combustion engine can be raised to satisfy a subsequently increasing power demand of the electric actuators.

Advantageously, with such a leading control of the internal combustion engine the actuators can directly and completely be supplied with current or electric energy by the generator, so that no intermediate storage of the electric energy generated is necessary. Corresponding electric energy accumulators such as batteries, rechargeable batteries and the like and corresponding controller modules for feeding in and feeding out the energy into such intermediate stores can be omitted. The electric actuators only need to be connected directly to the generator with their energy supply connections and can exclusively and completely be supplied with the energy currently provided by the generator. The actuators are supplied online so to speak directly by the generator. By saving batteries, rechargeable batteries and associated controller components for storing and delivering energy, the system can be of simple and inexpensive construction.

In accordance with a development of the invention the control device can execute the adjustment of the internal combustion engine more quickly or more slowly and/or possibly also delay the conversion of the control commands to the actuators or move the actuators to a desired operating point with a delay to always timely provide the power demand needed for the actuators by the internal combustion engine or the generator driven thereby. With increasing power demand of the actuators, the power output of the internal combustion engine and/or the related provision of power by the generator can be increased more quickly than the power demand of the actuators is rising. Alternatively, or in addition, with decreasing power demand of the actuators the power provided by the internal combustion engine can be reduced more slowly than the power of the actuator actually drops. In other words, with increasing power demand the internal combustion engine can be leading in terms of speed and/or torque and can be trailing with decreasing power demand.

Advantageously, the control device can comprise a speed control module for controlling the speed of the internal combustion engine, wherein the speed control module can be configured such that the internal combustion engine is adjusted with the smallest possible, but as large as necessary change in speed to just reach the operating condition necessary or desired for the power demand of the electric actuators to be expected without any major surpluses.

The control device can comprise an acceleration control module for controlling the acceleration of the internal combustion engine, wherein the acceleration control module can be configured such that the internal combustion engine is adjusted with the smallest possible, but as large as necessary acceleration to just in time reach the operating condition necessary or desired for the power demand to be expected. Since the internal combustion engine advantageously always is operated only with the minimum necessary acceleration to reach a new operating point, the mechanism of the internal combustion engine can be saved and an unnecessarily increased fuel consumption due to too fast an acceleration can be avoided.

Advantageously, the acceleration control module here can comprise determination means which with reference to the current operating condition of the electric actuators and the actuation of the input means or the entered control commands determine the point in time at which the actuators will have or reach the future power demand. With reference to this determined point in time or a correspondingly determined time period which is estimated for reaching the operating point of the actuators or is needed by the actuators, the acceleration control module then can determine the necessary acceleration of the internal combustion engine to timely reach the operating range necessary or desired for the power demand of the actuators occurring at this time.

The control device and the engine control unit can be configured such that the future power demand is calculated so quickly and the internal combustion engine is adjusted so quickly that the internal combustion engine reaches the operating point calculated for the future power demand, shortly before or at the latest when the electric actuators reach their anticipated, final operating point. It thereby is possible that the crane can be operated without a loss of performance and nevertheless a saving of fuel is achieved.

In accordance with a development of the invention, the engine control unit can comprise a speed control device for variably controlling the speed of the internal combustion engine in dependence on the future power demand and in dependence on the current operating condition of the actuators. Alternatively, or in addition, the engine control unit also can comprise a torque control device by means of which alternatively or in addition to a speed control the torque of the internal combustion engine can be controlled in dependence on the future power demand. The engine control unit however also can do solely with a speed control device and solely generate a speed control signal by means of which the internal combustion engine in advance is moved to the required operating point.

The determination of the future power demand with reference to which the internal combustion engine then is actuated in principle can be effected in various ways or consider various operating parameters. In accordance with an advantageous development of the invention, in particular a strength and/or velocity and/or direction of the actuation of the input means and/or a related magnitude and/or rate of change of a control command created by the input means can be considered. For example, the internal combustion engine can be adjusted more quickly when the input means for example in the form of a joystick for controlling the crane positioning movements is actuated more quickly, as a fast actuation involves a conclusion to a stronger deflection and hence a desire for a high positioning speed. Alternatively, or in addition, a deflection angle or an actuating path of the joystick or another input means can also be considered, for example to the effect that a stronger or farther deflection is converted into a relatively fast increase of the speed and/or the torque of the internal combustion engine, as a strong joystick movement implies a stronger increase of the power demand.

Alternatively, or in addition to such consideration of the actuation speed and/or actuation acceleration and/or of the actuation path of the input means the number of the actuators concerned with the entered control commands also can be considered for the determination of the future power demand. For example, when a control command for lifting the hoisting gear and a control command for rotating the boom or traveling the gantry is issued at the same time or one after the other, a greater increase of the power demand can be assumed, while in the case of a control command for only one actuator a smaller future power demand can be assumed. Correspondingly, in the case of an input of control commands which concern several actuators the engine control unit can provide a stronger and/or faster adjustment of the operating point of the internal combustion engine and/or in the case of only few or only one actuator concerned can provide a smaller and/or slower adjustment of the operating point of the internal combustion engine.

Alternatively, or in addition, it can also be considered for the determination of the power demand which one of the actuators should be concerned with an entered control command or should be adjusted as desired. For example, upon actuation of the hoisting gear a power demand can be assumed which increases more strongly than upon actuation of the slewing gear or the bridge traveling drive. In so far, the future power demand can be determined in dependence on the identity of the actuator concerned with the control commands.

Alternatively, or in addition, the requested speed and/or the requested direction of a positioning movement also can be considered for the determination of the future power demand. When a crane operator for example requests a quick lift by a corresponding actuation of the input means, the future power demand can be estimated higher than for the case in which the crane operator only requests a slow lift.

In accordance with a development of the invention the control device and/or the engine control unit also takes account of the generator speed for an optimum voltage supply of the electric actuators. The speed and/or the torque of the internal combustion engine can be adapted to the demand of the generator with reference to the determined future power demand. For example, the engine control unit can consider that the voltage to be provided by the generator can depend on its speed. Therefore, for a predetermined power demand which is accompanied by a certain voltage level or voltage demand, the internal combustion engine can be brought to a speed which would not be necessary with respect to the power of the internal combustion engine, but which considers the conditions of the generator and takes account of the same. For example, the internal combustion engine also can be brought to an increased speed, even if the internal combustion engine itself would be able to provide the required power even at a lower speed, to consider the conditions of the generator by the aforementioned increased speed and to operate the same in a frequency range in which it can provide the required voltage.

The electric actuators of the crane advantageously can be actuated by the control device via a frequency converter.

In accordance with a development of the invention the control device also can consider the power level of the internal combustion engine in the actuation of the electric actuators, in such that crane movements are limited regarding the velocity and/or acceleration and/or simultaneous execution to limit the electric power demand required for the crane movements such that the performance of the internal combustion engine is not reached or not exceeded. Overloads of the internal combustion engine and a resulting stalling of the internal combustion engine thereby can be prevented. The performance protection for the internal combustion engine by limiting the power consumption of the electric actuators can be expedient when for example the internal combustion engine cannot comply with its rated power, for example because of a defective injection nozzle, a clogged fuel filter, or the like.

The power limitation for the electric actuators can be realized in different ways, for example by limiting the maximum lifting speed or the maximum traveling speed of the respective actuator. Alternatively, or in addition, a velocity and/or acceleration ramp can be flattened or limited for controlling the respective actuator. Possibly, it can also already be sufficient to execute simultaneously requested positioning movements of two or more actuators one after the other, so that the power demands of the actuators are not to be added up, but are obtained one after the other. Other control strategies to account for the performance limits of the internal combustion engine are possible.

The invention will be explained in more detail in the following with respect to preferred embodiments and to associated drawings. There are shown in the drawings.

### BRIEF DESCRIPTION OF THE DRAWINGS

FIG. 1 is a schematic representation of a crane in the form of a container stacking crane with rubber tires, wherein the partial views a and b show the crane in front and side views, and

FIG. 2 is a schematic representation of the control device of the crane, which estimates or determines the future power demand of the electric actuators of the crane of FIG. 1 in advance and controls the internal combustion engine of the crane of FIG. 1, which drives its generator to supply the electric drives with energy, in dependence on the future power demand.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways.

As used in the specification and the appended Claims, the singular forms “a,” “an” and “the” include plural references unless the context clearly dictates otherwise. For example, reference to a component is intended also to include a composition of a plurality of components. References to a composition containing “a” constituent is intended to include other constituents in addition to the one named.

In describing exemplary embodiments, terminology will be resorted to for the sake of clarity. It is intended that each term contemplates its broadest meaning as understood by those skilled in the art and includes all technical equivalents that operate in a similar manner to accomplish a similar purpose.

Ranges may be expressed as from “about” or “approximately” or “substantially” one value and/or to “about” or “approximately” or “substantially” another value. When such a range is expressed, other exemplary embodiments include from the one value and/or to the other value.

Similarly, as used herein, “substantially free” of something, or “substantially pure”, and like characterizations, can include both being “at least substantially free” of something, or “at least substantially pure”, and being “completely free” of something, or “completely pure”.

“Comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

The characteristics described as defining the various elements of the invention are intended to be illustrative and not restrictive. For example, if the characteristic is a material, the material includes many suitable materials that would perform the same or a similar function as the material(s) described herein are intended to be embraced within the scope of the invention. Such other materials not described herein can include, but are not limited to, for example, materials that are developed after the time of the development of the invention.

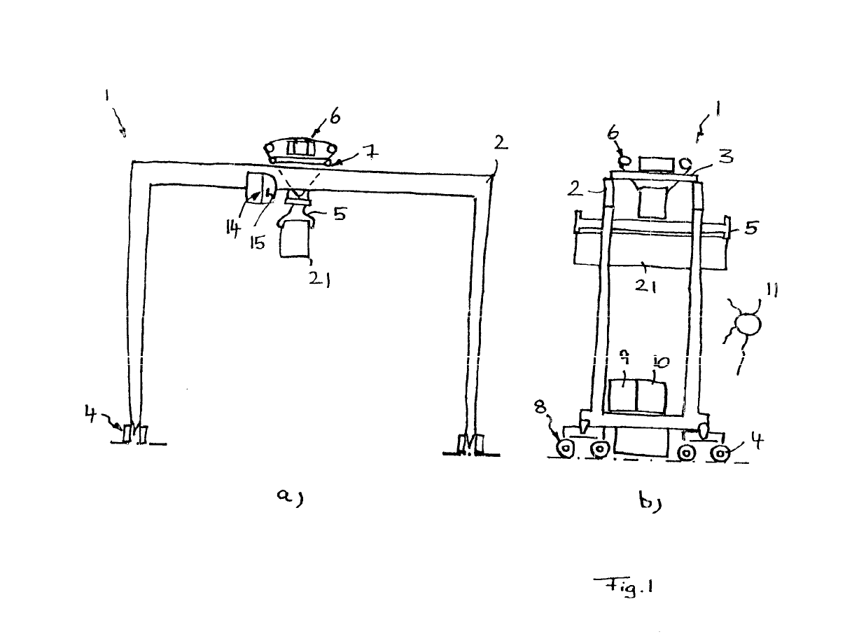

As shown in FIG. 1, the crane 1 can be configured as container stacking crane, which includes a gantry 2 that can be traveled on a container loading station by means of a traveling gear 4 provided with rubber tires, for example. On the gantry 2 a transversely movable bridge 3 can be arranged, on which a hoisting harness 5, by means of which a container 21 can be grasped, is mounted to be lifted and lowered.

For adjusting the crane elements electric actuators are provided, in particular a hoisting drive 6 for lifting and lowering the hoisting harness 5, which for example can be effected by means of a hoisting cable and corresponding cable winches, then a bridge drive 7 by means of which the bridge 3 can be traveled along the gantry 2, and a traveling drive 8 by means of which the traveling gear 4 can be driven.

The electric actuators 6, 7 and 8 can be fed with electric energy by a generator 9 which can be driven by an internal combustion engine 10 for example in the form of a diesel engine.

For controlling the crane positioning movements input means 14 are provided for a crane operator, which can be arranged in a crane operator stand 22 and for example can comprise a joystick 15, input keys, control levers or slide switches and the like. By means of the input means 4 control commands can be generated or entered, which serve the actuation of the actuators in the form of the hoisting drive 6, the bridge drive 7 and the traveling drive 8.

In dependence on the control commands an electric control device 11 can then actuate the actuators, which advantageously can be effected via a frequency converter which in a known way can convert the frequency generated by the generator 9.

The control device 11 furthermore adapts the speed and/or the torque of the internal combustion engine 10 to the respective crane operating condition to on the one hand provide for handling the crane without any disadvantages in terms of performance and on the other hand achieve the lowest possible fuel consumption.

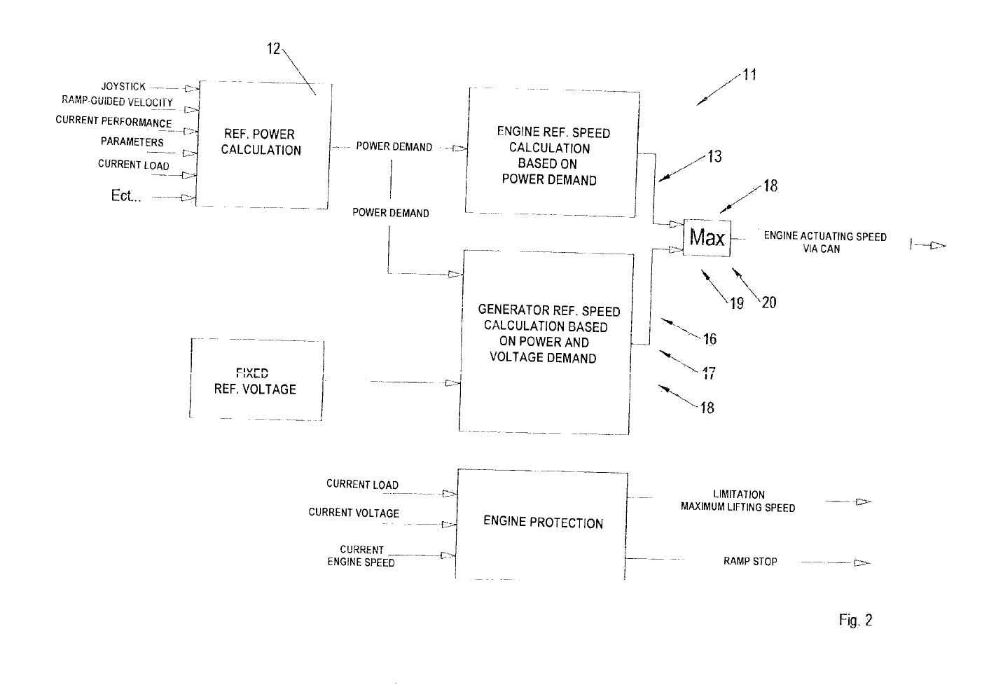

As shown in FIG. 2, the control device 11 therefor can comprise a determination device 12 by means of which the future power demand of the actuators and hence the power required by the internal combustion engine 10 and the generator 9 is calculated and determined or estimated with reference to the current operating condition of the actuators 6, 7 and 8 and the actuation of the input means 14. For this purpose, various sensor signals and/or items of information are supplied to the determination device 12, which can indicate the actuation of the input means, the crane operating condition and the structural characteristics of the crane. In particular, as is shown in FIG. 2, information on the actuation of the joystick 15, information on the actuation speed, information on the actual performance of the actuators and/or of the internal combustion engine and/or of the generator, information on further operating parameters such as internal combustion engine speed, internal combustion engine torque, traveling or adjustment speed of the actuators or of other crane elements, and/or information on the actual load on the crane elements and/or other information can be supplied to the determination device 12.

As described above, the determination device 12 of the control device 11 therefrom calculates the future power demand which occurs when the electric actuators 6, 7 and 8 reach the operating point requested by the control commands entered.

From the determined future power demand, the engine control unit 13 of the control device 11 then calculates the operating point or operating range required therefor, in particular the speed and/or torque of the internal combustion engine 10.

The engine control unit 13, as shown in FIG. 2, also considers the conditions and necessities of the generator 9, in particular what speed the generator actually needs to be able to provide the voltage and amount of electricity necessary for the future power demand. Generator characteristics such as voltage output via speed and the like can be considered here. In addition, framework conditions such as a fixed reference voltage needed can be considered.

As the result of this calculation process the engine control unit 13 then determines the actual operating point for the internal combustion engine 10, wherein the engine control unit 13 here can also calculate the acceleration with which the internal combustion engine 10 is brought to the new operating point. The engine control unit 13 and/or the control device 11 therefor can include an acceleration control module 16 which by time determination means 17 calculates the point in time or the time period at which or in which the electric actuators 6, 7 and 8 reach the anticipated operating point at which the future power demand actually occurs. Then, acceleration determination means 18 therefrom calculate the necessary acceleration for the internal combustion engine 10.

As shown in FIG. 2, the engine control unit 13 and/or the control device 11 can do only with an actuating speed command for the engine. It is not necessary to additionally also generate an actuating signal for the torque, although this would be possible in principle.

A speed controller 19 and/or a torque controller 20 of the engine control unit 13 then bring the internal combustion engine 10 into the desired operating point.

1. A crane comprising:
electric actuators;
a generator for supplying the electric actuators with energy;
an internal combustion engine for driving the generator;
input means for entering control commands for the actuators; and
a control device configured to control the actuators in dependence on the control commands entered;
wherein the control device comprises:
a determination device configured to estimate and/or determine a future power demand of the actuators on the basis of the actuation of the input means and the current operating condition of the actuators; and
an engine control unit configured to control the internal combustion engine in dependence on the estimated/determined future power demand.

2. The crane according to claim 1, wherein the control device further comprises an acceleration control module configured to control the acceleration of the internal combustion engine and/or the actuators such that with increasing future power demand, the internal combustion engine is brought into its operating condition determined for the future power demand, before the actuators reach the future power demand.

3. The crane according to claim 2, wherein the acceleration control module is further configured such that the internal combustion engine is adjusted with a minimally necessary and/or a smallest possible acceleration with which the operating condition of the internal combustion engine required for the determined future power demand is just reached in time.

4. The crane according to claim 1, wherein the acceleration control module comprises:
determination means configured to determine a point in time and/or a time period in which the actuators reach the future power demand; and
acceleration determination means configured to determine the acceleration of the internal combustion engine in dependence on the determined point in time or the determined time period.

5. The crane according to claim 1, wherein the engine control unit comprises a speed control device configured to variably control the speed of the internal combustion engine in dependence on the future power demand and the current operating condition of the actuators.

6. The crane according to claim 5, wherein the speed control device is further configured to adjust a minimally necessary and/or a smallest possible change in speed with which the future power demand is reached.

7. The crane according to claim 1, wherein the engine control unit includes a torque control device configured to variably control the torque of the internal combustion engine in dependence on the future power demand and the current operating condition of the actuators.

8. The crane according to claim 1, wherein the electric actuators are directly and completely supplied with energy from the generator.

9. The crane according to claim 1, wherein the control device is further configured to actuate the actuators via a frequency converter.

10. The crane according to claim 1, wherein the control device is further configured to limit the velocity and/or acceleration of the actuators by considering the performance limit of the internal combustion engine.

11. The crane according to claim 1, wherein the determination device is further configured to determine the future power demand of the electric actuators with reference to one or more of:
a strength of the actuation of the input means;
a velocity of the actuation of the input means;
a direction of the actuation of the input means;
the number of actuators concerned with an entered control command;
the identity of the actuator concerned with a control command;
the velocity requested by the entered control commands; and
the requested direction of the actuating movement of the actuator concerned with the control commands.

12. The crane according to claim 1, wherein the engine control unit is further configured to determine the speed of the internal combustion engine in dependence on the speed-voltage curve of the generator.

13. A method for controlling a crane (1) with electric actuators for lifting and/or traveling loads and/or crane elements, a generator for supplying the electric actuators with energy, an internal combustion engine for driving the generator, input means for entering control commands for the actuators, and a control device for controlling the actuators in dependence on the control commands entered, the method comprising:
detecting an actuation of the input means and/or the control commands generated by the actuation of the input means;
calculating and/or estimating and/or determining a future power demand of the actuators by the control device with reference to the detected actuation of the input means and/or with reference to the detected control commands generated by the actuation of the input means; and
adjusting the internal combustion engine with regard to the speed and/or torque to an operating point in which the internal combustion engine provides the calculated/estimated power demand substantially without an excess of power, before the actuators reach the operating point requested by the control commands of the input means and the corresponding power demand.

14. The crane according to claim 1, wherein no intermediate storage of the electric energy generated by the generator is provided.

15. A crane comprising:
a determination device for one or both determining and estimating a future power demand of actuators on the basis of the actuation of input means for entering control commands for the actuators and a current operating condition of the actuators; and
an engine control unit for controlling an internal combustion engine that drives a generator that supplies the actuators with energy in dependence on the determined/estimated future power demand.

16. The crane according to claim 15 further comprising:
the actuators comprising electric actuators;
the generator;
the internal combustion engine;
the input means; and
an acceleration control module configured to control the acceleration of one or both of the internal combustion engine and the electric actuators such that with increasing future power demand, the internal combustion engine is brought into an operating condition determined for the future power demand, before the electric actuators reach the future power demand;
wherein the determination device, the engine control unit and the acceleration control module form a control device configured to control the actuators in dependence on the control commands entered;
wherein the acceleration control module is further configured such that the internal combustion engine is adjusted with a minimally necessary and/or a smallest possible acceleration with which the operating condition of the internal combustion engine required for the determined future power demand is just reached in time; and
wherein the engine control unit comprises a speed control device configured to:
variably control the speed of the internal combustion engine in dependence on the future power demand and the current operating condition of the electric actuators; and
adjust the minimally necessary and/or the smallest possible change in speed with which the future power demand is reached.

17. The crane according to claim 16, wherein the engine control unit includes a torque control device configured to variably control the torque of the internal combustion engine in dependence on the future power demand and the current operating condition of the actuators;
wherein the electric actuators are directly and completely supplied with energy from the generator;
wherein the control device is further configured to actuate the actuators via a frequency converter; and
wherein the control device is further configured to limit the velocity and/or acceleration of the actuators by considering the performance limit of the internal combustion engine.

18. The crane according to claim 17, wherein the determination device is further configured to determine the future power demand of the electric actuators with reference to one or more of:
a strength of the actuation of the input means;
a velocity of the actuation of the input means;
a direction of the actuation of the input means;
the number of actuators concerned with an entered control command;
the identity of the actuator concerned with a control command;
the velocity requested by the entered control commands; and
the requested direction of the actuating movement of the actuator concerned with the control commands.

19. The crane according to claim 18, wherein the engine control unit is further configured to determine the speed of the internal combustion engine in dependence on the speed-voltage curve of the generator.

20. The crane according to claim 19, wherein the acceleration control module comprises:
determination means configured to determine a point in time and/or a time period in which the actuators reach the future power demand; and
acceleration determination means configured to determine the acceleration of the internal combustion engine in dependence on the determined point in time or the determined time period.
